(19) United States
(12) Patent Application Publication
(10) Pub. No.: US 2026/0057459 A1
(43) Pub. Date: Feb. 26, 2026

(54) INFORMATION PROCESSING APPARATUS

(71) Applicant: TOYOTA JIDOSHA KABUSHIKI KAISHA, Toyota-shi (JP)

(72) Inventor: Chiaki Kataoka, Nagakute-shi (JP)

(73) Assignee: TOYOTA JIDOSHA KABUSHIKI KAISHA, Toyota-shi (JP)

(21) Appl. No.: 19/226,707

(22) Filed: Jun. 3, 2025

(30) Foreign Application Priority Data
Aug. 23, 2024 (JP) 2024-143204

(51) Int. Cl. G06Q 50/06; G06Q 10/0631; G08B 21/18

(52) U.S. Cl. CPC G06Q 50/06; G06Q 10/06315; G08B 21/182

(57) ABSTRACT

An information processing apparatus includes a storage unit in which information on a plurality of hydrogen consuming devices that operates by receiving supply of hydrogen from an attachable and detachable hydrogen tank is registered, a remaining amount acquisition unit that acquires a hydrogen remaining amount of the hydrogen tank based on information transmitted from a hydrogen consuming device to which the hydrogen tank is loaded among the plurality of hydrogen consuming devices, a calculation unit that calculates an operable amount of each of the plurality of hydrogen consuming devices in accordance with the hydrogen remaining amount acquired by the remaining amount acquisition unit, and a display control unit that causes a calculation result by the calculation unit to be displayed at a predetermined display unit.

### CROSS-REFERENCE TO RELATED APPLICATION

This application claims priority to Japanese Patent Application No. 2024-143204 filed on Aug. 23, 2024. The disclosure of the above-identified application, including the specification, drawings, and claims, is incorporated by reference herein in its entirety.

### BACKGROUND

### 1. Technical Field

The technology disclosed in the present specification relates to information processing related to use of a hydrogen tank.

### 2. Description of Related Art

A hydrogen tank attachable and detachable to and from a hydrogen consuming device that consumes hydrogen is known.

Japanese Unexamined Patent Application Publication No. 2023-56869 (JP 2023-56869 A) discloses a fuel cell electric vehicle on which a fuel cell and a hydrogen cooker that use hydrogen as fuel are mounted. According to JP 2023-56869 A, a hydrogen tank is attachable and detachable to and from this fuel cell electric vehicle, and hydrogen is supplied to the fuel cell and the hydrogen cooker from the hydrogen tank loaded to the fuel cell electric vehicle.

### SUMMARY

A user can use an attachable and detachable hydrogen tank in various hydrogen consuming devices by loading the attachable and detachable hydrogen tank to a certain hydrogen consuming device, and then, detaching it and loading it to another hydrogen consuming device. Assuming such a use aspect, it is inconvenient for the user if the user doesn't know how long each of the hydrogen consuming devices can be used when the hydrogen tank is loaded.

The present specification presents a technology for improving convenience of the user who uses an attachable and detachable hydrogen tank to a hydrogen consuming device.

The present specification discloses an information processing apparatus. The information processing apparatus includes a storage unit in which information on a plurality of hydrogen consuming devices that operates by receiving supply of hydrogen from an attachable and detachable hydrogen tank is registered, a remaining amount acquisition unit that acquires a hydrogen remaining amount of the hydrogen tank based on information transmitted from a hydrogen consuming device to which the hydrogen tank is loaded among the plurality of hydrogen consuming devices, a calculation unit that calculates an operable amount of each of the plurality of hydrogen consuming devices in accordance with the hydrogen remaining amount acquired by the remaining amount acquisition unit, and a display control unit that causes a calculation result by the calculation unit to be displayed at a predetermined display unit.

According to the above-described configuration, the information processing apparatus calculates the operable amount of each of the plurality of hydrogen consuming devices in accordance with the hydrogen remaining amount acquired by the remaining amount acquisition unit and causes the calculation result to be displayed at the display unit. This allows the user to know how much longer each of the hydrogen consuming devices can be used when the attachable and detachable hydrogen tank is loaded.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view simply illustrating a system configuration of a first embodiment;

FIG. 2 is a flowchart indicating processing to be executed by each of a hydrogen consuming device and an information processing apparatus in the first embodiment;

FIG. 3 is a view indicating an example of history of a hydrogen remaining amount with a graph;

FIG. 4 is a view illustrating an example of a hydrogen tank information screen;

FIG. 5 is a view illustrating another example of the hydrogen tank information screen; and

FIG. 6 is a view for explaining a second embodiment.

### DETAILED DESCRIPTION OF EMBODIMENTS

The present embodiment will be described with reference to the drawings. Each drawing is merely an example, and the present embodiment is not limited to the illustrated content. Further, each drawing is an example, and thus, part of the illustration is omitted.

### First Embodiment

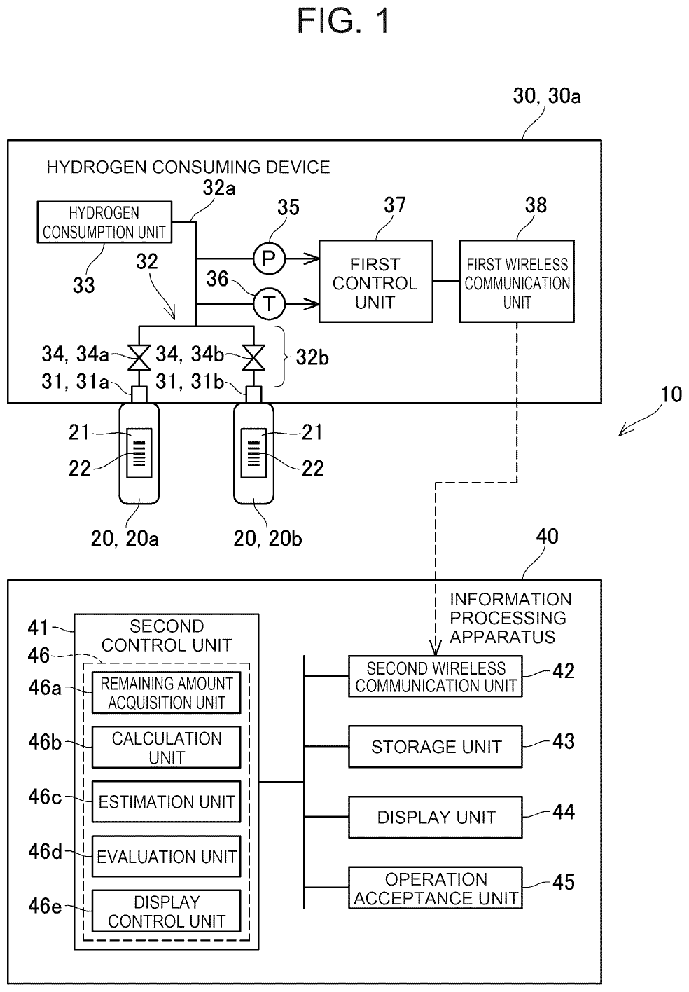

FIG. 1 simply illustrates a configuration of a system 10 according to a first embodiment. The system 10 includes a hydrogen tank 20, a hydrogen consuming device 30, and an information processing apparatus 40. The hydrogen tank 20 is filled with hydrogen. The hydrogen tank 20 is an attachable and detachable hydrogen tank. A user can load the hydrogen tank 20 to a connection port 31 of a desired hydrogen consuming device 30 or detach the hydrogen tank 20 from the connection port 31 of the hydrogen consuming device 30. The hydrogen tank 20 may be, for example, referred to as a hydrogen cartridge.

A tag 21 is attached to the hydrogen tank 20. On the tag 21, unique identification information (hereinafter, a hydrogen tank ID) for identifying each of the hydrogen tanks 20 is printed or described. The hydrogen tank ID may be a character string that can be read by the user. Alternatively, the hydrogen tank ID may be written in a code 22 such as a barcode and a two-dimensional code, and the code 22 may be printed on the tag 21.

The hydrogen consuming device 30 can operate by receiving supply of hydrogen from the hydrogen tank 20 loaded to the connection port 31. The hydrogen consuming device 30 is, for example, a mobile body, an electric generator, a hydrogen cooker, or the like, using hydrogen as fuel. The mobile body is a ship, a flight vehicle, or the like, as well as a four-wheel vehicle, a two-wheel vehicle, a caddie cart, or the like. The hydrogen consuming device 30 includes a hydrogen consumption unit 33 that actually consumes hydrogen supplied from the hydrogen tank 20 through the connection port 31 and a flow path 32. The hydrogen consumption unit 33 is, for example, a fuel cell or a hydrogen engine mounted on the above-described mobile body, or the like, or a hydrogen stove provided in the hydrogen cooker. One hydrogen consuming device 30 may include a plurality of hydrogen consumption units 33.

While the hydrogen consuming device 30 only requires to have at least one connection port 31, the hydrogen consuming device 30 has a plurality of connection ports 31 in the example in FIG. 1. The user can attach and detach the hydrogen tank 20 to and from each of the plurality of connection ports 31. The flow path 32 includes a common flow path 32a connected to the hydrogen consumption unit 33, and a branched flow path 32b branched so as to correspond to each connection port 31 between the common flow path 32a and each connection port 31. On the branched flow paths 32b, valves 34 that open and close the branched flow paths 32b are provided so as to correspond to the connection ports 31 on a one-to-one basis. The valve 34 is, for example, an electromagnetic valve.

Further, the hydrogen consuming device 30 includes a pressure sensor 35, a temperature sensor 36, a first control unit 37, a first wireless communication unit 38, and the like. The first control unit 37 is one type of a controller that controls the hydrogen consuming device 30, and includes, for example, at least one of electronic control units (ECUs) mounted on the hydrogen consuming device 30. The first control unit 37 can control supply of hydrogen to the hydrogen consumption unit 33 for each hydrogen tank 20 by individually opening and closing the valves 34 corresponding to the connection ports 31 on a one-to-one basis.

The pressure sensor 35 and the temperature sensor 36 are attached to the common flow path 32a. The pressure sensor 35 detects a gas pressure of a hydrogen gas flowing through the common flow path 32a. The temperature sensor 36 detects a gas temperature of the hydrogen gas flowing through the common flow path 32a. A detection result by each of the pressure sensor 35 and the temperature sensor 36 is output to the first control unit 37.

The plurality of hydrogen tanks 20 illustrated in FIG. 1 may be distinguished from each other by being expressed as hydrogen tanks 20a, 20b. Further, the connection port 31 to which the hydrogen tank 20a is loaded is expressed as a connection port 31a, and the valve 34 corresponding to the connection port 31a is expressed as a valve 34a. In a similar manner, the connection port 31 to which the hydrogen tank 20b is loaded is expressed as a connection port 31b, and the valve 34 corresponding to the connection port 31b is expressed as a valve 34b. The first control unit 37 can acquire the gas pressure and the gas temperature for each of the plurality of hydrogen tanks 20 by individually opening and closing the valves 34 corresponding to the connection ports 31 on a one-to-one basis.

In other words, according to the example in FIG. 1, the first control unit 37 can cause the pressure sensor 35 to detect the gas pressure of the hydrogen tank 20a and cause the temperature sensor 36 to detect the gas temperature of the hydrogen tank 20a by closing the valve 34b and opening the valve 34a. By this means, the first control unit 37 acquires the gas pressure and the gas temperature of the hydrogen tank 20a. In a similar manner, the first control unit 37 causes the pressure sensor 35 to detect the gas pressure of the hydrogen tank 20b and causes the temperature sensor 36 to detect the gas temperature of the hydrogen tank 20b by closing the valve 34a and opening the valve 34b. By this means, the first control unit 37 acquires the gas pressure and the gas temperature of the hydrogen tank 20b.

The first control unit 37 calculates a hydrogen remaining amount of the hydrogen tank 20 based on the gas pressure and the gas temperature. The first control unit 37 can calculate the hydrogen remaining amount, for example, by inputting the gas pressure and the gas temperature to a function or a table set in advance. It is only necessary to employ a publicly known method as a method for calculating the hydrogen remaining amount based on the gas pressure and the gas temperature, and thus, details will be omitted. In either case, the first control unit 37 can calculate the hydrogen remaining amount of the hydrogen tank 20a based on the gas pressure and the gas temperature of the hydrogen tank 20a acquired from the pressure sensor 35 and the temperature sensor 36. In a similar manner, the first control unit 37 can calculate the hydrogen remaining amount of the hydrogen tank 20b based on the gas pressure and the gas temperature of the hydrogen tank 20b acquired from the pressure sensor 35 and the temperature sensor 36.

The first wireless communication unit 38 is a generic term of interfaces to be used by the hydrogen consuming device 30 to execute wireless communication. The wireless communication includes so-called near field communication, and communication through a network line. The first wireless communication unit 38 can communicate with the information processing apparatus 40 and external apparatuses other than the information processing apparatus 40.

The information processing apparatus 40 includes a second control unit 41, a second wireless communication unit 42, a storage unit 43, a display unit 44, an operation acceptance unit 45, and the like. The second control unit 41 includes a processor and a memory. The processor functions as, for example, a remaining amount acquisition unit 46a, a calculation unit 46b, an estimation unit 46c, an evaluation unit 46d, a display control unit 46e, and the like, by executing a program 46 stored in the memory, or the like. The program 46 can be regarded as one of applications installed in the information processing apparatus 40.

The information processing apparatus 40 is an apparatus that executes the program 46. The information processing apparatus 40 is, for example, a smartphone to be operated by the user. Alternatively, the information processing apparatus 40 may be one of various information processing apparatuses such as a personal computer (PC), a tablet terminal, various kinds of mobile terminals and a server. The information processing apparatus 40 may be a system that is implemented by a plurality of apparatuses connected so as to be able to perform communication as well as being implemented by one apparatus.

The second wireless communication unit 42 is a generic term of interfaces to be used by the information processing apparatus 40 to execute wireless communication. It goes without saying that the hydrogen consuming device 30 and the information processing apparatus 40 may be able to execute communication with outside in a wired manner as well as through wireless communication. In the present embodiment, any communication standards may be employed.

The storage unit 43 is constituted with a storage medium. A memory provided in the second control unit 41 may be regarded as at least part of the storage unit 43, or the storage unit 43 may be regarded as part of the second control unit 41. The display unit 44 is means for displaying visual information and corresponds to one example of a “predetermined display unit”. However, the predetermined display unit may be an external display apparatus different from the display unit 44 provided in the information processing apparatus 40.

The operation acceptance unit 45 is a generic term of user interfaces for accepting operation by the user. The operation acceptance unit 45 corresponds to, for example, a switch, a button, a keyboard, a mouse, or the like. If the display unit 44 also functions as a touch panel, the display unit 44 also serves as at least part of the operation acceptance unit 45.

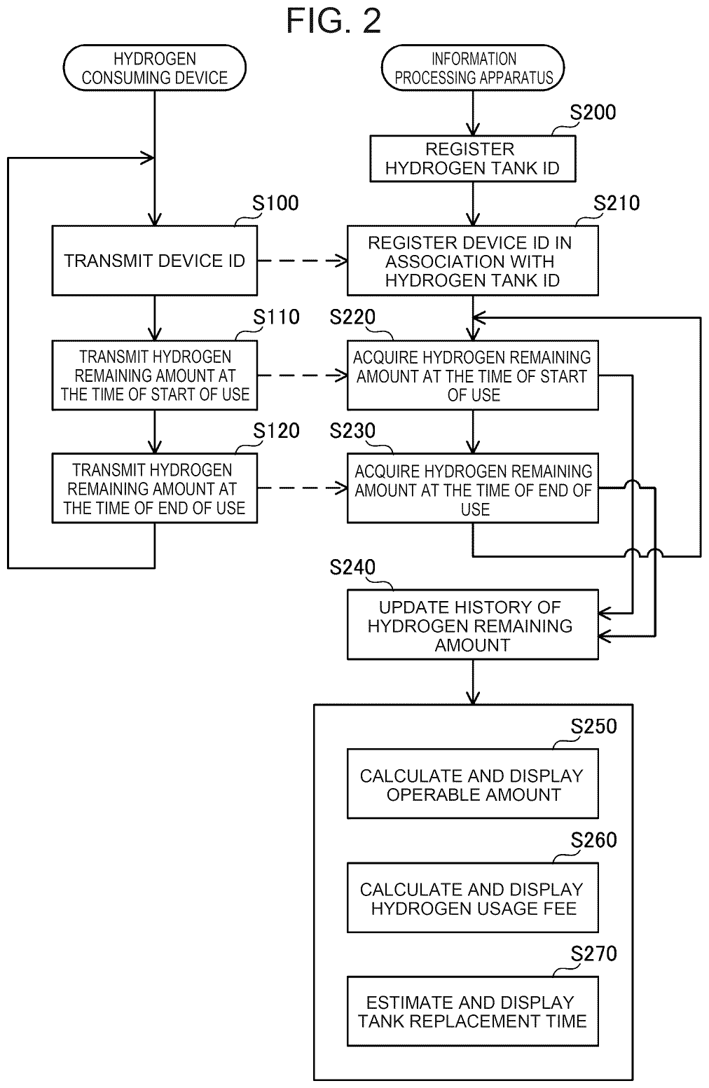

FIG. 2 indicates processing to be executed by each of the hydrogen consuming device 30 and the information processing apparatus 40 in the first embodiment in parallel in a flowchart format. The second control unit 41 of the information processing apparatus 40 registers a hydrogen tank ID (step S200). The hydrogen tank 20 is, for example, provided to the user from a business operator that provides a service of providing the hydrogen tank 20. In a case where the user receives provision of the hydrogen tank 20, first, the user performs a work of registering the hydrogen tank ID of the hydrogen tank 20 in the information processing apparatus 40. The user, for example, operates the operation acceptance unit 45 to input the hydrogen tank ID of the hydrogen tank 20 to the information processing apparatus 40. Alternatively, the user may input the hydrogen tank ID to the information processing apparatus 40 by causing a barcode scanner (not illustrated) connected to the information processing apparatus 40 to read the code 22 or causing a camera (not illustrated) provided in the information processing apparatus 40 to read the code 22.

In step S200, the second control unit 41 registers the hydrogen tank ID input by the user in this manner in the storage unit 43 in association with identification information of the user. The identification information of the user is personal identification information of the user that has already been recognized as the user of the information processing apparatus 40 by the second control unit 41. Then, the user loads the hydrogen tank 20 for which the hydrogen tank ID is registered in the information processing apparatus 40, to the connection port 31 of the desired hydrogen consuming device 30.

Description of FIG. 2 will be continued blow using an example of a state where the user registers the hydrogen tank ID of the hydrogen tank 20a in the information processing apparatus 40, and the hydrogen tank 20a is loaded to the connection port 31a of a “hydrogen consuming device 30a” which is one of the hydrogen consuming devices 30. Further, it is assumed that the hydrogen tanks 20 other than the hydrogen tank 20a are unregistered in the information processing apparatus 40, and the hydrogen tanks 20 other than the hydrogen tank 20a are not loaded to the hydrogen consuming device 30a unless otherwise described.

In the hydrogen consuming device 30a, the first control unit 37 transmits a device ID of the hydrogen consuming device 30a to the information processing apparatus 40 through the first wireless communication unit 38 (step S100). The device ID is unique identification information for identifying each of the hydrogen consuming devices 30 and is attached in advance for each hydrogen consuming device 30. The first control unit 37 executes the processing of step S100, for example, when the hydrogen consuming device 30a is started. In other words, the processing of step S100 is executed at a timing at which the user starts the hydrogen consuming device 30a.

The information processing apparatus 40 receives the device ID transmitted in step S100 through the second wireless communication unit 42. By this means, the second control unit 41 registers the device ID in the storage unit 43 in association with the hydrogen tank ID (step S210). In other words, the second control unit 41 recognizes that the user uses the hydrogen tank 20a in the hydrogen consuming device 30a by associating the user, the registered hydrogen tank ID and the received device ID with one another. However, in a case where the device ID registered in the storage unit 43 in association with the hydrogen tank ID is received again, the second control unit 41 does not need to register the device ID in association with the hydrogen tank ID again.

In the hydrogen consuming device 30a, the first control unit 37 calculates the hydrogen remaining amount at the time of start of use of the hydrogen tank 20a and transmits a value of the hydrogen remaining amount to the information processing apparatus 40 through the first wireless communication unit 38 (step S110). While the time of start of use described here does not necessarily have to be strictly defined, for example, the first control unit 37 calculates the hydrogen remaining amount based on the gas pressure and the gas temperature respectively detected by the pressure sensor 35 and the temperature sensor 36 immediately after, for example, predetermined seconds after the valve 34a is opened to start supply of hydrogen to the hydrogen consumption unit 33. Then, the first control unit 37 only requires to transmit this hydrogen remaining amount to the information processing apparatus 40 as the hydrogen remaining amount at the time of start of use of the hydrogen tank 20a.

Further, in the hydrogen consuming device 30a, the first control unit 37 calculates the hydrogen remaining amount at the time of end of use of the hydrogen tank 20a and transmits a value of this hydrogen remaining amount to the information processing apparatus 40 through the first wireless communication unit 38 (step S120). While the time of end of use described here does not necessarily have to be strictly defined, for example, the first control unit 37 calculates the hydrogen remaining amount based on the gas pressure and the gas temperature respectively detected by the pressure sensor 35 and the temperature sensor 36 immediately before the valve 34a is closed when it is determined to end supply of hydrogen to the hydrogen consumption unit 33. Then, the first control unit 37 only requires to transmit this hydrogen remaining amount to the information processing apparatus 40 as the hydrogen remaining amount at the time of end of use of the hydrogen tank 20a.

In the information processing apparatus 40, the hydrogen remaining amount at the time of start of use transmitted in step S110 is received through the second wireless communication unit 42, thereby the remaining amount acquisition unit 46a acquires the hydrogen remaining amount at the time of start of use of the hydrogen tank 20a (step S220). Further, in the information processing apparatus 40, the hydrogen remaining amount at the time of end of use transmitted in step S120 is received through the second wireless communication unit 42, thereby the remaining amount acquisition unit 46a acquires the hydrogen remaining amount at the time of end of use of the hydrogen tank 20a (step S230).

Calculation of the hydrogen remaining amount based on the gas pressure and the gas temperature may be executed by the information processing apparatus 40 instead of the hydrogen consuming device 30a. In other words, in step S110 and step S120, the first control unit 37 may transmit information on the gas pressure and the gas temperature respectively detected by the pressure sensor 35 and the temperature sensor 36 to the information processing apparatus 40 through the first wireless communication unit 38. Then, in step S220 and step S230, the remaining amount acquisition unit 46a may acquire the hydrogen remaining amount at the time of start of use of the hydrogen tank 20a or acquire the hydrogen remaining amount at the time of end of use of the hydrogen tank 20a by calculating the hydrogen remaining amount based on the received information on the gas pressure and the gas temperature.

In a case where the user arbitrarily repeats start and stop of the hydrogen consuming device 30a in a state where the hydrogen tank 20a is loaded to the hydrogen consuming device 30a, that is, in a case where use of the hydrogen tank 20a is intermittently repeated, the processing from step S100 to S120 is repeatedly executed as indicated in FIG. 2. In accordance with this, the processing of step S220, S230 is repeated in the information processing apparatus 40. The information processing apparatus 40 naturally grasps date and time at which the information transmitted in step S110 is received, and date and time at which the information transmitted in step S120 is received.

Thus, the remaining amount acquisition unit 46a updates information regarding the hydrogen remaining amount (history of the hydrogen remaining amount) including a period during which the hydrogen tank 20a is used by the hydrogen consuming device 30a and a hydrogen consumption amount during the use period every time the processing of step S220, S230 is repeated (step S240). The remaining amount acquisition unit 46a causes the history of the hydrogen remaining amount to be stored in the storage unit 43 and updates the history of the hydrogen remaining amount. For example, a period from the date and time at which the information transmitted in step S110 is received until the date and time at which the information transmitted in step S120 is received is grasped as a period of one-time use of the hydrogen tank 20a. Further, a difference between the hydrogen remaining amount acquired in step S220 and the hydrogen remaining amount acquired in step S230 is grasped as the hydrogen consumption amount during the period of one-time use.

Further, the processing from step S100 to step S120 is performed in a similar manner to the hydrogen consuming device 30a also for the hydrogen consuming devices 30 different from the hydrogen consuming device 30a. For example, the hydrogen consuming device 30a will be referred to as a “first hydrogen consuming device”, and the respective hydrogen consuming devices 30 different from the hydrogen consuming device 30a will be referred to as a “second hydrogen consuming device”, a “third hydrogen consuming device”, and the like. The user can load and detach the hydrogen tank 20a to and from various hydrogen consuming devices 30 such as the first hydrogen consuming device, the second hydrogen consuming device and the third hydrogen consuming device at a desired timing.

According to such a situation, the first hydrogen consuming device, the second hydrogen consuming device and the third hydrogen consuming device execute the processing from step S100 to step S120 at different times. Thus, in the information processing apparatus 40 that executes the processing from step S210 to step S230 so as to correspond to step S100 to S120, the remaining amount acquisition unit 46a acquires the use period and the hydrogen consumption amount for each of the hydrogen consuming devices 30 (device IDs) as the history of the hydrogen remaining amount of the hydrogen tank 20a (step S240). In this manner, the remaining amount acquisition unit 46a acquires the hydrogen remaining amount of the hydrogen tank 20a based on the information transmitted from the hydrogen consuming device 30 to which the hydrogen tank 20a is loaded among the plurality of hydrogen consuming devices 30.

Next, step S250, S260, S270 will be described. Each of the processing of step S250, S260, S270 is executed with reference to the history of the hydrogen remaining amount updated as needed by the remaining amount acquisition unit 46a as described above. In the present embodiment, timings and the number of times of execution of the processing of step S250, S260, S270 are not particularly limited. The second control unit 41 may execute the processing of step S250, S260, S270 in specific order or may execute at least part of them at the same time. The second control unit 41 may execute each of the processing of step S250, S260, S270 in accordance with operation by the user.

The calculation unit 46b calculates an operable amount of each of the plurality of hydrogen consuming devices 30 in accordance with the hydrogen remaining amount acquired by the remaining amount acquisition unit 46a, and the display control unit 46e causes the calculation result by the calculation unit 46b to be displayed at the display unit 44 (step S250). The plurality of hydrogen consuming devices 30 described here refers to the hydrogen consuming devices 30 for which the device IDs are registered in the storage unit 43 at the time point of step S250. As one example, it is assumed that the device IDs of the first hydrogen consuming device, the second hydrogen consuming device and the third hydrogen consuming device are registered in the storage unit 43 in association with the user and the registered hydrogen tank ID (hydrogen tank ID of the hydrogen tank 20a). According the one example, the storage unit 43 corresponds to a “storage unit in which information on the plurality of hydrogen consuming devices 30 is registered”at the time point of step S250.

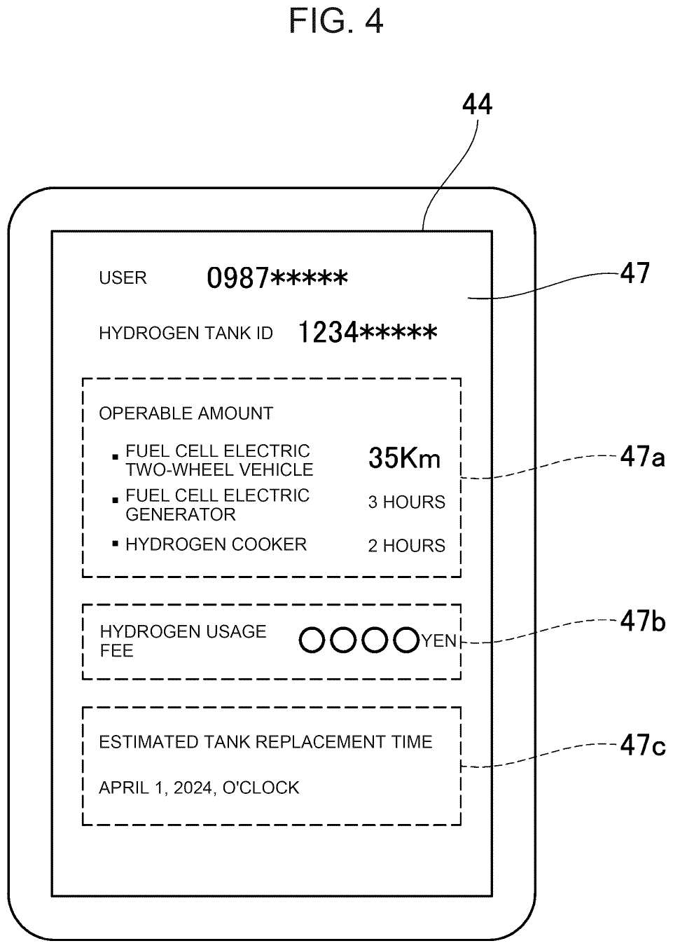

The operable amount is different for each hydrogen consuming device 30, and is, for example, movable (cruising) distance or an operable time length. The calculation unit 46b recognizes the hydrogen remaining amount of the hydrogen tank 20a with reference to the latest history of the hydrogen remaining amount at the time and calculates the operable amount for each hydrogen consuming device 30 in accordance with this hydrogen remaining amount. It is assumed that the calculation unit 46b can determine a type of the hydrogen consuming device 30 in accordance with the device ID. As one example, it is assumed that the first hydrogen consuming device is a fuel cell electric two-wheel vehicle, the second hydrogen consuming device is a fuel cell electric generator, and the third hydrogen consuming device is a hydrogen cooker (see FIG. 4). Thus, the calculation unit 46b converts the hydrogen remaining amount into a movable distance of the fuel cell electric two-wheel vehicle using a predetermined conversion equation, conversion table, or the like, and sets the movable distance as the operable amount of the first hydrogen consuming device. Further, the calculation unit 46b converts the hydrogen remaining amount into an operable time length of the fuel cell electric generator or an operable time length of the hydrogen cooker and sets the operable time length as the operable amount of each of the second hydrogen consuming device and the third hydrogen consuming device.

The calculation unit 46b calculates a hydrogen usage fee corresponding to the hydrogen consumption amount in the hydrogen tank 20a based on the history of the hydrogen remaining amount acquired by the remaining amount acquisition unit 46a, and the display control unit 46e causes the calculation result by the calculation unit 46b to be displayed at the display unit 44 (step S260).

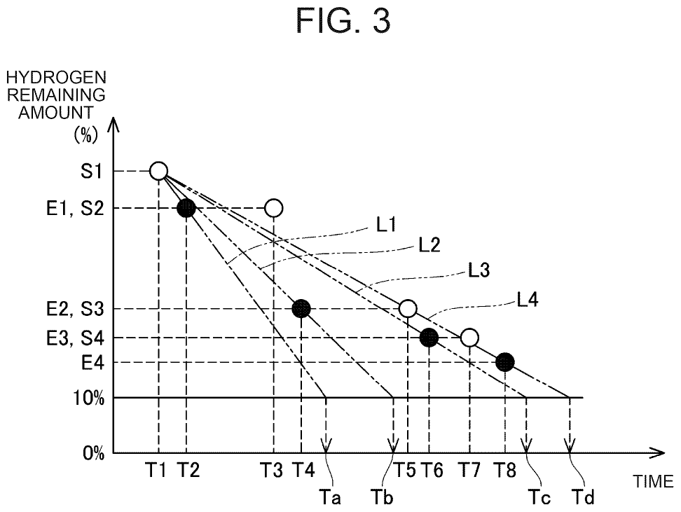

FIG. 3 simply indicates the history of the hydrogen remaining amount of the hydrogen tank 20a. FIG. 3 indicates the remaining amounts of hydrogen acquired by the remaining amount acquisition unit 46a with white circles and black circles in a two-dimensional coordinate system in which the hydrogen remaining amount is indicated on a vertical axis, and time is indicated on a horizontal axis. The white circle means the hydrogen remaining amount at the time of start of use of the hydrogen tank 20a acquired in step S220, and the black circle means the hydrogen remaining amount at the time of end of use of the hydrogen tank 20a acquired in step S230. In the example in FIG. 3, use periods of four-time use of the hydrogen tank 20a are indicated. A period from time T1 to time T2 will be referred to as a first use period, a period from time T3 to time T4 will be referred to as a second use period, a period from time T5 to time T6 will be referred to as a third use period, and a period from time T7 to time T8 will be referred to as a fourth use period. Each of the first to the fourth use periods is a use period of the hydrogen tank 20a when the hydrogen tank 20a is loaded to one of the first to the third hydrogen consuming devices.

A difference between a hydrogen remaining amount S1 at the time of start of the first use period and a hydrogen remaining amount E1 at the time of end of the first use period corresponds to a hydrogen consumption amount of the first use period. The hydrogen remaining amount S1 at the time of start of the first use period that is the first use period for the hydrogen tank 20a may be regarded as, for example, 100%. In a similar manner, a difference between a hydrogen remaining amount S2 at the time of start of the second use period and a hydrogen remaining amount E2 at the time of end of the second use period is a hydrogen consumption amount of the second use period. A difference between a hydrogen remaining amount S3 at the time of start of the third use period and a hydrogen remaining amount E3 at the time of end of the third use period is a hydrogen consumption amount of the third use period, and a difference between a hydrogen remaining amount S4 at the time of start of the fourth use period and a hydrogen remaining amount E4 at the time of end of the fourth use period is a hydrogen consumption amount of the fourth use period.

Such a hydrogen remaining amount is a value obtained through calculation, and thus, for example, the hydrogen remaining amount E1 at the time of end of the first use period does not necessarily coincide with the hydrogen remaining amount S2 at the time of start of the second use period. However, the hydrogen remaining amount E1 should theoretically or substantially coincide with the hydrogen remaining amount S2, and thus, FIG. 3 simply indicates these values as the same value. For a similar reason, FIG. 3 indicates the hydrogen remaining amount E2 and the hydrogen remaining amount S3 as the same value and indicates the hydrogen remaining amount E3 and the hydrogen remaining amount S4 as the same value.

The calculation unit 46b, for example, grasps a difference between a maximum hydrogen remaining amount S1 and a minimum hydrogen remaining amount E4 obtained with reference to the history of the hydrogen remaining amount as the hydrogen consumption amount in the hydrogen tank 20a at the present moment. Further, this hydrogen consumption amount is converted into the hydrogen usage fee based on a predetermined table of fees, or the like.

The estimation unit 46c estimates a time for replacement (tank replacement time) of the hydrogen tank 20a based on the history of the hydrogen remaining amount acquired by the remaining amount acquisition unit 46a. The display control unit 46e causes the tank replacement time estimated by the estimation unit 46c to be displayed at the display unit 44 (step S270).

The estimation unit 46c, for example, generates lines that respectively connect the hydrogen remaining amount S1 at the time of start of the first use period and the hydrogen remaining amounts E1 to E4 at the time of end of the respective use periods as estimation lines L1 to L4 in the two-dimensional coordinate system indicated in FIG. 3. FIG. 3 indicates the estimation lines L1 to L4 with dash-double-dot lines. The estimation unit 46c estimates times at which the estimation lines L1 to L4 reach a line of a predetermined remaining amount, for example, the hydrogen remaining amount of 10% as the tank replacement time. According to FIG. 3, a time at which the estimation line L1 reaches a line of the hydrogen remaining amount of 10% is time Ta. Further, times at which the estimation lines L2, L3 and L4 respectively reach a line of the hydrogen remaining amount of 10% are time Tb, Tc, Td.

Thus, in a period from when the first use period ends until when the second use period ends, the estimation line L1 is valid, and the estimation result of the tank replacement time by the estimation unit 46c is time Ta. Further, in a period from when the second use period ends until when the third use period ends, the estimation line L2 is valid, and the estimation result of the tank replacement time by the estimation unit 46c is time Tb. In a period from when the third use period ends until when the fourth use period ends, the estimation line L3 is valid, and the estimation result of the tank replacement time by the estimation unit 46c is time Tc. In a period after the fourth use period ends, the estimation line L4 is valid, and the estimation result of the tank replacement time by the estimation unit 46c is time Td.

The estimation unit 46c may set the above-described predetermined remaining amount at 0%. In other words, the estimation unit 46c may estimate times at which the estimation lines L1 to L4 reach the hydrogen remaining amount of 0% as the tank replacement time. A method for estimating the tank replacement time by the estimation unit 46c is not limited to the above-described method. The estimation unit 46c may, for example, generate a line or a curve approximating coordinates of the respective remaining amounts of hydrogen in the two-dimensional coordinate system indicated in FIG. 3 and may estimate a time at which the line or the curve generated by approximating the coordinates reaches the predetermined remaining amount as the tank replacement time.

FIG. 4 illustrates a hydrogen tank information screen 47 caused to be displayed at the display unit 44 by the display control unit 46e. As a result of step S250, for example, an operable amount 47a is displayed on the hydrogen tank information screen 47 along with the identification information of the user and the hydrogen tank ID of the hydrogen tank 20a. According to FIG. 4, the operable amount 47a specifically indicates the movable distance and the operable time length calculated by the calculation unit 46b for each of the hydrogen consuming devices 30 for which the device IDs are registered such as the fuel cell electric two-wheel vehicle, the fuel cell electric generator and the hydrogen cooker. The device ID for each hydrogen consuming device 30 may be also indicated on the hydrogen tank information screen 47. Through such display of the hydrogen tank information screen 47, the user can specifically know how much longer the remaining hydrogen can be used when the hydrogen tank 20a is loaded for each of the plurality of hydrogen consuming devices 30.

According to FIG. 4, as a result of step S260, a hydrogen usage fee 47b calculated by the calculation unit 46b is displayed on the hydrogen tank information screen 47. This allows the user to know the hydrogen usage fee in accordance with the hydrogen consumption amount so far of the hydrogen tank 20a. Further, according to FIG. 4, as a result of step S270, a tank replacement time 47c estimated by the estimation unit 46c is displayed on the hydrogen tank information screen 47. This allows the user to know when the hydrogen tank 20a should be replaced with a new hydrogen tank 20.

According to FIG. 4, the operable amount 47a, the hydrogen usage fee 47b and the tank replacement time 47c are displayed on the hydrogen tank information screen 47 at the same time, this is merely one example. The display control unit 46e may display the operable amount 47a, the hydrogen usage fee 47b and the tank replacement time 47c within a common screen at the same time or may display them on different screens or at different timings. For example, each of the operable amount 47a, the hydrogen usage fee 47b and the tank replacement time 47c may be displayed by the user switching the screen of the display unit 44.

In step S270, the estimation unit 46c may estimate a time earlier than a time at which the hydrogen tank 20a becomes empty as the tank replacement time based on the history of the hydrogen remaining amount acquired by the remaining amount acquisition unit 46a. Time Ta, Tb, Tc, Td indicated in FIG. 3 are examples of times earlier than the time at which the hydrogen tank 20a becomes empty. Then, the display control unit 46e may cause a notification that encourages replacement of the hydrogen tank 20a to be displayed at the display unit 44 when the replacement time estimated by the estimation unit 46c in this manner has come.

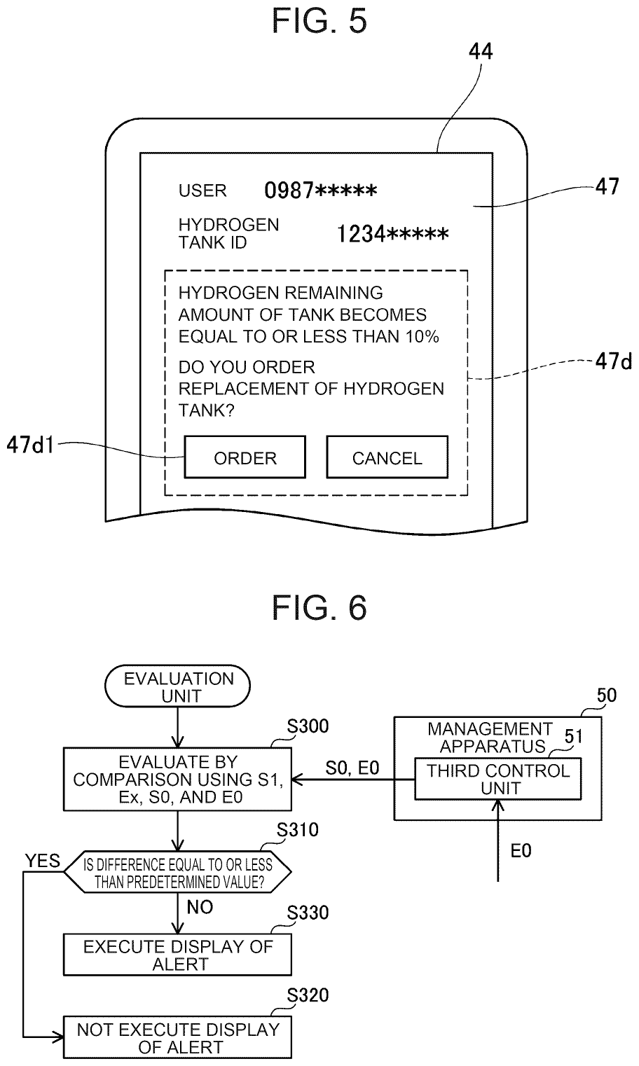

FIG. 5 illustrates an example of the hydrogen tank information screen 47 caused to be displayed at the display unit 44 by the display control unit 46e, different from FIG. 4. According to FIG. 5, a tank replacement request notification 47d is displayed on the hydrogen tank information screen 47. The tank replacement request notification 47d is one example of the notification that encourages replacement of the hydrogen tank 20a. The estimation unit 46c, for example, estimates time Td as the tank replacement time, and, when current date and time has reached time Td, the display control unit 46e causes the tank replacement request notification 47d to be displayed at the display unit 44. By this means, the user recognizes that the hydrogen tank 20a should be replaced. The tank replacement request notification 47d may include an order button 47d1, or the like, of the hydrogen tank 20. The user can operate the order button 47d1. In a case where the order button 47d1 is operated, the information processing apparatus 40 notifies the above-described business operator of an order of replacing the hydrogen tank 20 by some kind of communication means such as an e-mail.

The present embodiment has been described above assuming a situation where the user can use a certain one hydrogen tank 20a in various hydrogen consuming devices 30 by loading the hydrogen tank 20a to the various hydrogen consuming devices 30. On the other hand, the user can use a plurality of hydrogen tanks 20. For example, it is assumed that hydrogen tank IDs of the hydrogen tanks 20a, 20b are registered in the storage unit 43 in association with the identification information of the user. In such a case, the information processing apparatus 40 performs the processing from step S210 to step S270 for each of the hydrogen tanks 20. In the hydrogen consuming device 30, the first control unit 37 can grasp when and which of the hydrogen tanks 20 is used through opening and closing of each valve 34. Thus, when the first control unit 37 transmits information such as the hydrogen remaining amount to the information processing apparatus 40 in step S110 and step S120, the first control unit 37 also transmits information (such as the hydrogen tank ID) that specifies the hydrogen tank 20 corresponding to these kinds of information. In response to this, the second control unit 41 grasps the hydrogen remaining amount as needed for each of the hydrogen tanks 20a, 20b. Thus, the second control unit 41 can present to the user, respective kinds of information such as the operable amount 47a, the hydrogen usage fee 47b, the tank replacement time 47c and the tank replacement request notification 47d for each of the hydrogen tanks 20 such as the hydrogen tanks 20a, 20b.

### Second Embodiment

A second embodiment will be described next. Concerning the second embodiment, points different from the first embodiment will be described, and description in common with the first embodiment will be omitted. FIG. 6 is a view for explaining the second embodiment. FIG. 6 includes a flowchart to be executed by the evaluation unit 46d of the information processing apparatus 40 in part.

A management apparatus 50 is an external apparatus when viewed from the information processing apparatus 40, and is, for example, an information processing apparatus such as a PC and a server to be used by the above-described business operator. Alternatively, the management apparatus 50 may be a certain one hydrogen consuming device 30. Alternatively, in a case where the information processing apparatus 40 is implemented by a plurality of apparatuses connected so as to be able to perform communication, the management apparatus 50 may be one apparatus included in such a system (information processing apparatus 40). The management apparatus 50 may be part of the system 10 or may be a component not included in the system 10.

The management apparatus 50 naturally includes typical functions as the information processing apparatus, such as a processor that executes a program, a memory, a function of communicating with outside, and a user interface. A third control unit 51 that is a controller of the management apparatus 50 acquires the last hydrogen remaining amount E0 of the hydrogen tank 20a from outside. The last hydrogen remaining amount E0 is a hydrogen remaining amount measured in the hydrogen tank 20a collected from the user. For example, the business operator who has received the above-described replacement order provides a new hydrogen tank 20 to the user and collects the hydrogen tank 20a that has become unnecessary from the user. Then, the business operator measures the hydrogen remaining amount of the collected hydrogen tank 20a and inputs the measurement result to the management apparatus 50 as the hydrogen remaining amount E0. However, any method may be used as a method for acquiring the hydrogen remaining amount E0 by the management apparatus 50.

The third control unit 51 transmits the last hydrogen remaining amount E0 and the first hydrogen remaining amount S0 of the hydrogen tank 20a to the second control unit 41, and the evaluation unit 46d acquires the hydrogen remaining amount S0 and the hydrogen remaining amount E0. The first hydrogen remaining amount S0 is a hydrogen remaining amount measured in the hydrogen tank 20a before the hydrogen tank 20a is shipped to the user, and is, for example, measured in advance by the business operator. Alternatively, the hydrogen remaining amount S0 is a value defined under standards of the hydrogen tank 20a. The third control unit 51 has such a first hydrogen remaining amount S0 as information.

The hydrogen remaining amount S0 and the hydrogen remaining amount E0 correspond to an example of a “second hydrogen remaining amount” that is the hydrogen remaining amount of the hydrogen tank 20a acquired by the management apparatus 50. The evaluation unit 46d acquires the second hydrogen remaining amount from the management apparatus 50 and evaluates a difference between the second hydrogen remaining amount and the hydrogen remaining amount acquired by the remaining amount acquisition unit 46a (step S300). The hydrogen remaining amounts which are acquired by the remaining amount acquisition unit 46a and which are to be used for evaluation in step S300 are the hydrogen remaining amount S1 (see FIG. 3) at the time of start of the first use period and a hydrogen remaining amount Ex acquired by the remaining amount acquisition unit 46a last before collection for the hydrogen tank 20a. If the fourth use period is the last use period before collection for the hydrogen tank 20a, the hydrogen remaining amount E4 corresponds to the hydrogen remaining amount Ex.

While there are various evaluation methods to be performed in step S300, the evaluation unit 46d, for example, evaluates whether or not the following inequalities A, B, C are satisfied.

$$Inequality A : \vert S 0 - S 1 \vert \leq TH 1$$

$$Inequality B : \vert E 0 - Ex \vert \leq TH 2$$

$$Inequality C : \vert ( S 0 - E 0 ) - ( S 1 - Ex ) \vert \leq TH 3$$

The predetermined values TH1, TH2, TH3 are thresholds set in advance. TH1, TH2, TH3 may be the same value or may be different values. According to the inequality A, a difference between the first hydrogen remaining amount S0 of the hydrogen tank 20a recognized by the management apparatus 50 and the first hydrogen remaining amount S1 of the hydrogen tank 20a recognized by the information processing apparatus 40 based on the information from the hydrogen consuming device 30 to which the hydrogen tank 20a is loaded, is evaluated. According to the inequality B, a difference between the last hydrogen remaining amount E0 of the hydrogen tank 20a recognized by the management apparatus 50 and the last hydrogen remaining amount Ex of the hydrogen tank 20a recognized by the information processing apparatus 40 based on the information from the hydrogen consuming device 30 to which the hydrogen tank 20a is loaded, is evaluated. According to the inequality C, a difference between the hydrogen consumption amount (S0−E0) of the hydrogen tank 20a recognized by the management apparatus 50 and the hydrogen consumption amount (S1−Ex) of the hydrogen tank 20a recognized by the information processing apparatus 40 based on the information from the hydrogen consuming device 30 to which the hydrogen tank 20a is loaded, is evaluated.

The processing proceeds to step S320 in a case where the evaluation unit 46d evaluates that the difference is equal to or less than a predetermined value (step S310: Yes), and the processing proceeds to step S330 in a case where the evaluation unit 46d evaluates that the difference exceeds the predetermined value (step S310: No). For example, the evaluation unit 46d determines as “No” in step S310 in a case where one or more of the inequalities A, B and C are not satisfied. In step S330, the display control unit 46e causes a predetermined alert to be displayed at the display unit 44.

The alert is an alert indicating that an accurate hydrogen remaining amount cannot be acquired based on the information transmitted from the hydrogen consuming device 30 to which the hydrogen tank 20a is loaded. More specifically, the display control unit 46e may notify the user of a possibility that an abnormality or a defect may occur in the pressure sensor 35, the temperature sensor 36, the controller (first control unit 37), or the like, of the hydrogen consuming device 30, as the alert. Further, the display control unit 46e may notify the user of the alert including information from which the hydrogen consuming device 30 that is used with the hydrogen tank 20a being loaded can be specified, such as, for example, the device ID. In step S320, the flowchart ends without the alert being displayed. According to such a second embodiment, it is possible to allow the user to recognize that an accurate hydrogen remaining amount cannot be obtained based on the information transmitted from the hydrogen consuming device 30 to which the hydrogen tank 20a is loaded. This results in making it possible for the user to, for example, cancel use of the hydrogen consuming device 30.

### Third Embodiment

At least part of the processing described as being executed by the information processing apparatus 40 in the second embodiment may be executed by the management apparatus 50. Further, at least part of the processing described as being executed by the information processing apparatus 40 in the first embodiment may be executed by the management apparatus 50. In other words, the processing indicated in FIG. 2 may be executed by the management apparatus 50 acquiring necessary information from the information processing apparatus 40 as appropriate through communication between the information processing apparatus 40 and the management apparatus 50.

The management apparatus 50 can acquire the hydrogen remaining amount S0 and the hydrogen remaining amount E0, and thus, can accurately calculate the hydrogen usage fee of the hydrogen tank 20a in accordance with a difference between the hydrogen remaining amount S0 and the hydrogen remaining amount E0. Thus, the management apparatus 50 may cause the hydrogen usage fee calculated in accordance with the difference between the hydrogen remaining amount S0 and the hydrogen remaining amount E0 to be displayed at the display unit 44 of the information processing apparatus 40 or other display apparatuses to notify the user. Display of the hydrogen usage fee calculated in accordance with the difference between the hydrogen remaining amount S0 and the hydrogen remaining amount E0 may be executed instead of display in step S260 or may be executed as processing different from display in step S260.

While specific examples of the technology disclosed in the present specification have been described in detail above, these are merely examples, and do not limit the claims. The technology recited in the claims includes various modifications and changes of the specific examples described above. Further, technical components described in the present specification or the drawings exert technical utility alone or by various combinations, and the combinations are not limited to combinations recited in the claims as originally filed. Still further, the technology exemplified in the present specification or the drawings achieves a plurality of objects at the same time, and has technical utility by achieving one of the objects.

What is claimed is:

1. An information processing apparatus comprising:
a storage unit in which information on a plurality of hydrogen consuming devices that operates by receiving supply of hydrogen from an attachable and detachable hydrogen tank is registered;
a remaining amount acquisition unit that acquires a hydrogen remaining amount of the hydrogen tank based on information transmitted from a hydrogen consuming device to which the hydrogen tank is loaded among the plurality of hydrogen consuming devices;
a calculation unit that calculates an operable amount of each of the plurality of hydrogen consuming devices in accordance with the hydrogen remaining amount acquired by the remaining amount acquisition unit; and
a display control unit that causes a calculation result by the calculation unit to be displayed at a predetermined display unit.

2. The information processing apparatus according to claim 1, wherein the calculation unit calculates a hydrogen usage fee corresponding to a hydrogen consumption amount of the hydrogen tank based on history of the hydrogen remaining amount acquired by the remaining amount acquisition unit.

3. The information processing apparatus according to claim 1, comprising an estimation unit that estimates a replacement time of the hydrogen tank based on history of the hydrogen remaining amount acquired by the remaining amount acquisition unit,
wherein the display control unit causes the replacement time estimated by the estimation unit to be displayed at the display unit.

4. The information processing apparatus according to claim 3, wherein:
the estimation unit estimates a time earlier than a time at which the hydrogen tank becomes empty as the replacement time based on the history; and
the display control unit causes a notification that encourages replacement of the hydrogen tank to be displayed at the display unit when the replacement time estimated by the estimation unit has come.

5. The information processing apparatus according to claim 1, comprising an evaluation unit that acquires a second hydrogen remaining amount that is a hydrogen remaining amount of the hydrogen tank acquired by a management apparatus and evaluates a difference between the second hydrogen remaining amount and the hydrogen remaining amount acquired by the remaining amount acquisition unit,
wherein in a case where the evaluation unit evaluates that the difference exceeds a predetermined value, the display control unit causes a predetermined alert to be displayed at the display unit.
